(19) United States
(12) Patent Application Publication
(10) Pub. No.: US 2002/0189164 A1
(43) Pub. Date: Dec. 19, 2002

(54) Device for watering a flower pot

(76) Inventor: Lutz Bengsch, Oslo (NO)

Correspondence Address: JORDAN AND HAMBURG LLP, 122 EAST 42ND STREET, SUITE 4000, NEW YORK, NY, 10168, US

(21) Appl. No.: 10/068,225

(22) Filed: Feb. 5, 2002

(30) Foreign Application Priority Data
Feb. 16, 2001 (DE) 101 07 841.2
Apr. 6, 2001 (DE) 101 17 419.5-23

(51) Int. Cl. A01G 9/04

(52) U.S. Cl. 47/71; 47/81

(57) ABSTRACT

A device for watering a flowerpot, which can be placed in a lower position in an outer pot containing a supply of water at a distance from the bottom of the outer pot and set down in an upper position in the region of the upper edge of the outer pot, a wick being placed with one end in the flower pot for supplying it with water and, with the other end, into the supply of water, the device having a first setting-up device (2, 5) for setting down the flowerpot (17) in a lower position and a second setting-up device (8, 9), which can be placed on the outer pot (15) or inserted in the outer pot (15) and held in the region of the upper edge of the outer pot (15) by friction for placing the flowerpot (17) in the upper position.

The invention relates to a device for watering a flowerpot, which can be placed in a lower position in an outer pot containing a supply of water at a distance from the bottom of the outer pot and set down in an upper position in the region of the upper edge of the outer pot, a wick being placed with one end in the flower pot for supplying it with water and, with the other end, into the supply of water.

This device serves for the purpose of watering flowers or plants even in the absence of the owner. Moreover, the unintentional excessive watering of plants is avoided.

The EP 0 065 709 B1 discloses a device, which, in a first, folded together position, is placed in an outer pot and serves for setting down the flower pot. This device has hinged edge parts, which, in a second upper position, embrace the upper edge of the outer pot, so that the flowerpot can be placed thereon. The outer pot is filled with water, into which a wick, which is connected with the flowerpot, dips so that the plant can absorb moisture. However, this known device has the disadvantage that it must be fitted relatively accurately to the size and shape of the outer pot, or that different devices are required for outer pots of different sizes.

It is therefore an object of the invention to avoid the disadvantages named and to indicate a device, which can be used more flexibly.

Pursuant to the invention, this objective is accomplished by a device for watering a flowerpot of the type named above, which has a first setting-up device for placing down the flowerpot in a lower position and a second setting-up device, which can be placed on or inserted in the outer pot and held by friction in the region of the upper edge of the outer pot, for setting down the flowerpot in the upper position.

The inventive device consists of two separate setting-up devices. The first setting-up device is placed in the outer pot. The second setting-up device is placed on the edge of the outer pot and is therefore larger than the first setting-up device. Depending on the size relationships, it can also be placed in the outer pot and held by friction in the upper region of the outer pot. Feet can be detachably fastened to the setting-up devices, so that the setting-up device in the outer pot is at a distance from the bottom.

Advisably, the second setting-up device is ring-shaped. In this connection, the expression “ring-shaped” includes circular as well as polygonal setting-up devices, which can be placed on appropriately shaped outer pots. The setting-up devices can be triangular, rectangular, hexagonal, etc.

In a further development of the invention, provisions are made so that profiled sections, which extend preferably radially to the ring, are detachably fastened to the second setting-up device. It is particularly preferred if profiled sections, crossing one another in the region of the center of the ring, are detachably fastened to the second setting-up device. As a result, the setting down surface for the flowerpot consists of a ring, in the center of which there is a cross-like reinforcement. In this way, a secure stand and great stability are achieved for a flowerpot. It is also conceivable to use four profiled sections, which are fastened in the form of a rectangle at the second setting-up device.

A further increase in stability is achieved if the profiled sections protrude over the outside of the second setting-up device. An enlarged setting-up surface is achieved by these means.

In this connection the profiled sections preferably are placed in such a manner on the second setting-up device, that the upper sides of the profiled sections lie in one plane. The crossing region between two profiled sections accordingly is also level, so that tilting or wobbling is avoided.

Flowerpots, which are small in comparison to the outer pot, can be inserted in the case of the inventive device in such a manner in the second setting-up device, that their outer surfaces lie in frictional contact with the inner surface of the ring. For this purpose, the flowerpot is inserted in the ring-shaped second setting-up device. Flowerpots generally have a conically tapering surface, which, at a particular height, agrees with the internal diameter of the second setting-up device. After the flowerpot is inserted in the second setting-up device, the latter, depending on its size, is partially below the setting-up device, that is, within the outer pot, and partially above the setting-up device. The device therefore is suitable for a large number of different flowerpots and outer pots.

It is appropriate that the end of the wick, which is connected with the flowerpot, can be wound around a rod shaped wick holder, which can be inserted through an opening in the under side of the flowerpot. In an advantageous further development, provision can be made so that the wick holder has a groove around it, which extends at an angle to the longitudinal axis of the wick holder, so that the wick can be wound on the groove. The moistened contact surface, produced in this manner, is significantly larger than that of known wick holders, moisture being emitted uniformly and in all directions.

In a further development of the invention, provisions can be made so that at least one foot, for setting the flowerpot down in the outer pot, is integrally molded to the setting-up device. The flowerpot, placed thereon, is elevated so that the outer pot can be filled with water up to the level of the setting-up device without the flowerpot coming into contact with the water.

It is conceivable to construct the foot around the underside of the setting-up device. Several feet can also be disposed concentrically at the setting-up device. By these means, an improved stability is achieved, so that even heavy flowerpots can be set down thereon.

This device has the advantage that the setting-up device can not only be set down in the interior of an outer pot, but also placed on the edge of an outer pot. In order to achieve a better adaptation to outer pots and flowerpots of different sizes, holding elements, which protrude over the setting-up device on the inside and/or the outside, can be fastened to the setting-up device. For this purpose, the holding elements are constructed U-shaped in a further development of the invention and can be pushed with their open side preferably radially onto the setting-up device the legs of the holding element embracing the setting-up device on the upper side or the underside. By these means, a particularly good hold is achieved. The size relationships of the holding elements and of the setting-up device can therefore be coordinated with one another, so that the holding elements are held by friction and do not slip even under load.

An improved fastening is achieved if the setting-up device on its upper side and/or in the region of its feet has depressions and/or protrusions. Advisably, the inner surface of the holding elements are provided with the corresponding depressions or protrusions, which are constructed diametrically opposed to the corresponding surfaces of the setting-up device. The holding elements can then be pushed onto the setting-up device and locked positively. Nevertheless the size of the setting-up device can be adapted at all times by pushing the holding elements radially inward or outward if, for example, a flowerpot of a different size is to be used.

The area of use of the inventive device is increased further if the connection between the upper and lower legs of the holding element is constructed as a film hinge. In this case, it is not absolutely necessary that the upper and lower legs of the holding element coincide. For example, the lower leg may protrude further inward, so that a flowerpot rests on the lower leg and lies laterally against the upper leg. Particularly good stability is achieved by these means.

In the case of an alternative embodiment of the invention, holding elements, which can be swiveled inward and/or outward, can be fastened detachably to the setting-up device. These holding elements are connected with the setting-up device over a fastening point, which functions as fulcrum. They can be swiveled about this fulcrum, so that the total setting-up surface can be enlarged either in the interior of the setting-up device or towards the outside. Preferably, plug-in openings, into which the securing pins for fixing the holding elements can be inserted, are provided in the setting-up device. With that, shifting or slipping of the holding elements when they are subjected to a lateral load, is prevented. The securing pins can also be integrally molded to the holding elements.

According to a further alternative of the invention, an angular holding element can be used, which can be inserted into a recess of the setting-up device. Preferably, four holding elements are used, which are distributed over the periphery. A holding element may consists of three sections, which are disposed at right angles to one another, the two outer areas being parallel to one another. The holding element can be inserted into the recess of the setting-up device, so that a first surface lies against the upper side and a second surface against the underside of the setting-up device. The length of the middle surface of the holding element must correspond approximately to the thickness of the setting-up device.

The inventive device may be produced from a plastic material by injection molding. This production method is relatively inexpensive for larger number of units. In this connection, the inventive device preferably can be produced as a coherent injection-molded part, from which individual parts can be severed. The injection-molded part may include individual parts for several, preferably for two or three sets of devices. This variation is also particularly cost effective, since only a single mold is required for the manufacture. Moreover, the injection-molded part contains several individual parts of different size for the first as well as for the second setting-up device. These can be combined at will, so that there are setting-up devices, which are suitable for practically any application.

For manufacturing reasons, it is preferable that, in the case of an injection molded part comprising two sets of devices, the first setting-up device of the first set is constructed circularly and the first setting-up device of the second set and the second setting-up devices of the first and second sets are constructed as concentric rings, the external diameter of one part corresponding essentially to that of the adjacent part. This arrangement is distinguished by the small amount of material required as well as by the small size of the arrangement.

The injection-molded part may have at least four profiled sections, which preferably are disposed at right angles and advisably constructed as U-shaped profiles. In addition, each profiled section can have locking elements for locking to a setting-up surface, the locking elements being constructed, for example, as L-shaped angles, the free ends of which point to the outside in the longitudinal direction of the profiled section. The angles are disposed in each case in pairs at the same distance from the center of the profiled section, their position being adapted to the internal diameter of the ring-shaped second setting-up devices. Several, preferably two pairs of angles, which are provided for setting-up devices of different size, are disposed at one profiled section. For locking, a profiled section is placed on a second setting-up device, so that the free-ends of the angles embrace mutually-opposite sections of the circular opening.

In the following, the invention is explained in greater detail by means of several examples and with reference to diagrammatic drawings, in which

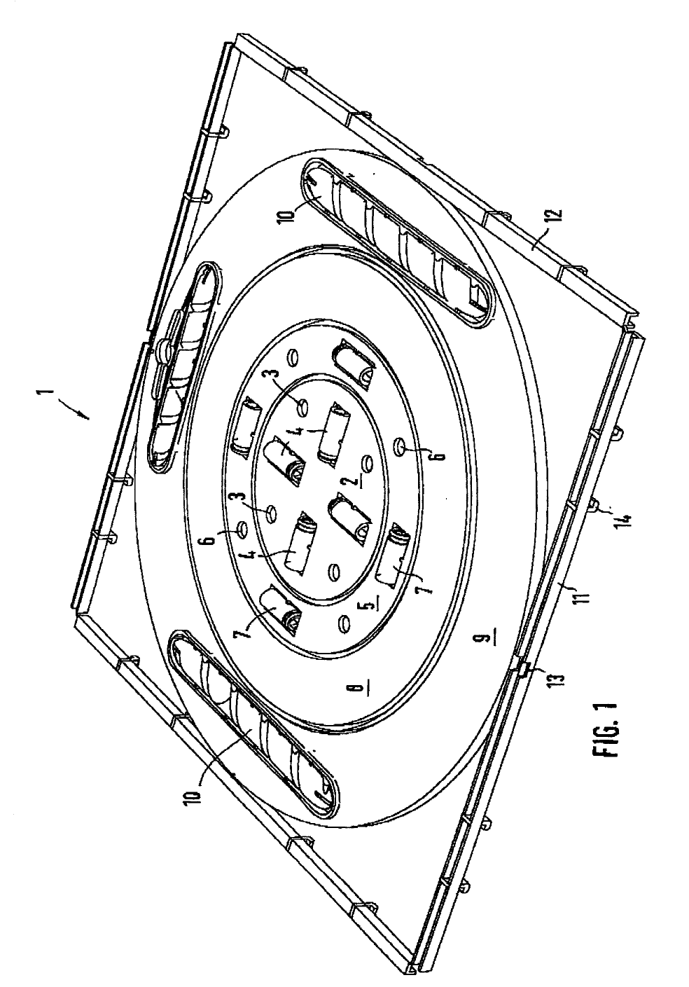

FIG. 1 shows an example of the inventive device, constructed as an injection-molded part, with individual parts, which can be severed,

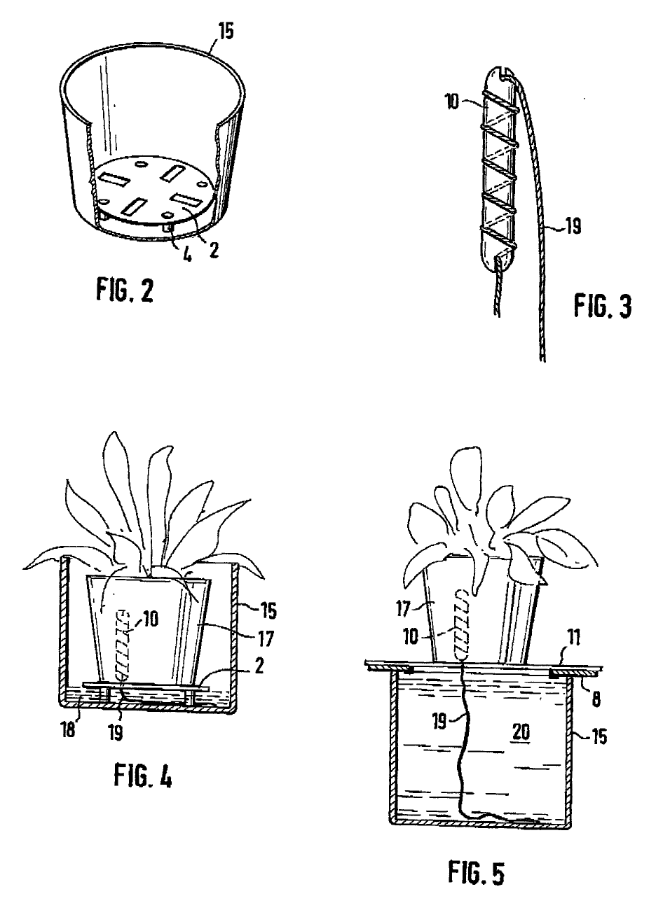

FIG. 2 shows a first setting-up device, which is inserted in an outer pot,

FIG. 3 shows a wick holder around which a wick is wound,

FIG. 4 shows a flowerpot, placed down on a first setting-up device in a lower position,

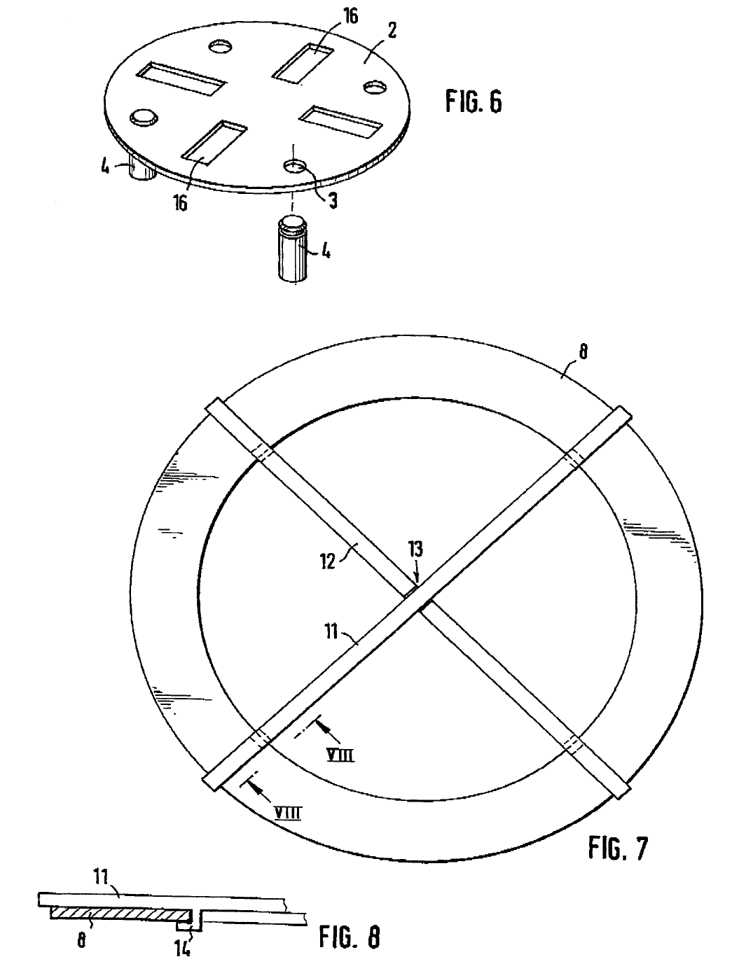

FIG. 5 shows the flowerpot, shown in FIG. 4, in an upper position

FIG. 6 shows the construction of a first setting-up device

FIG. 7 shows a second setting-up device, on which two mutally crossing profiled sections are fastened,

FIG. 8 shows a sectional view of a detail of the setting-up device of FIG. 7, along the line of VIII-VIII,

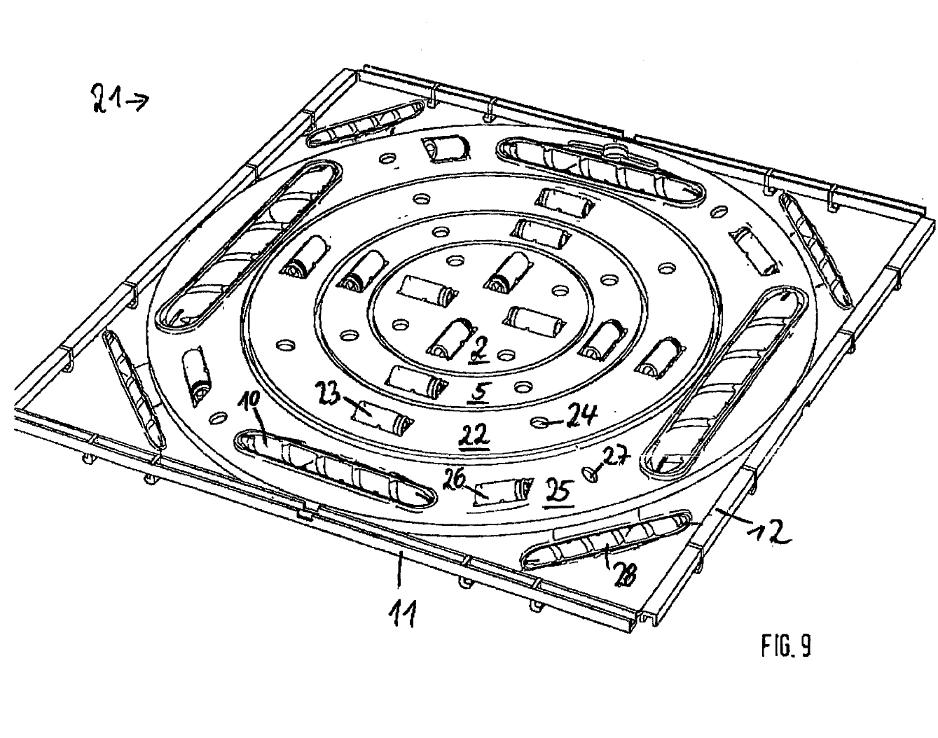

FIG. 9 shows a second example of the inventive device, which comprises a larger number of individual parts,

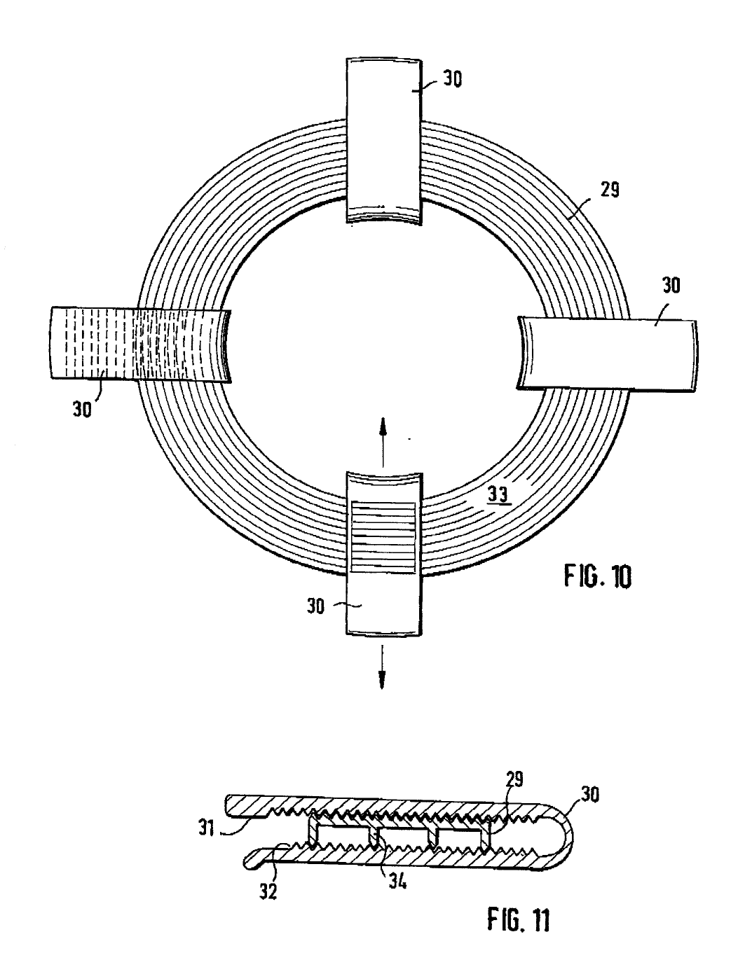

FIG. 10 shows a third example of the invention with a setting-up device, which can be adjusted by removable holding elements,

FIG. 11 shows a holding element of the setting-up device of FIG. 10,

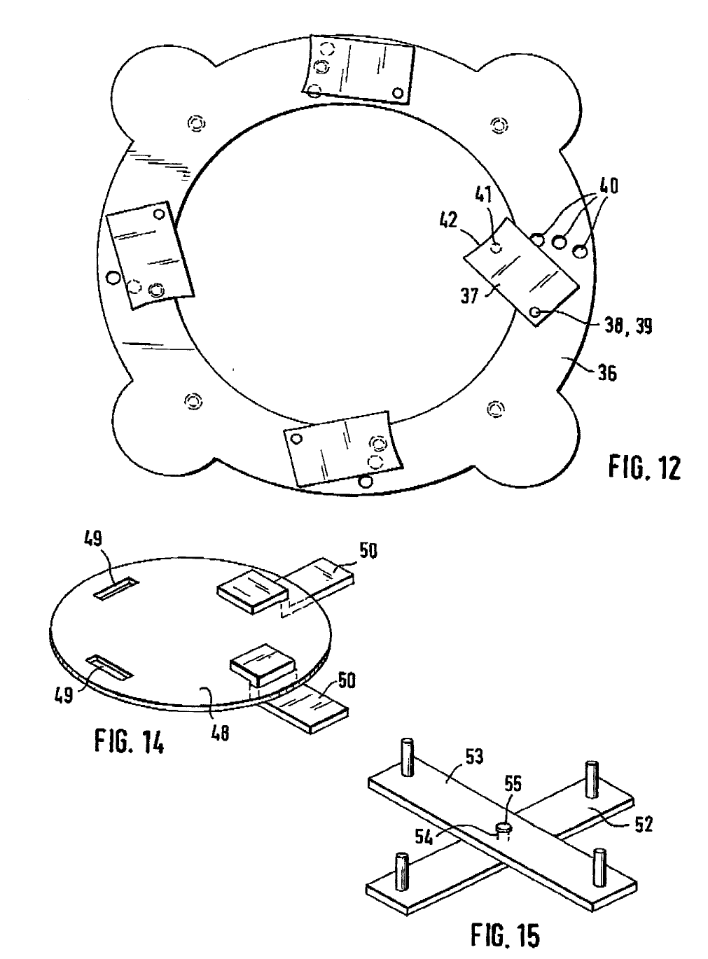

FIG. 12 shows a fourth example of the invention with a setting-up device, which can be adjusted by pivotable holding elements,

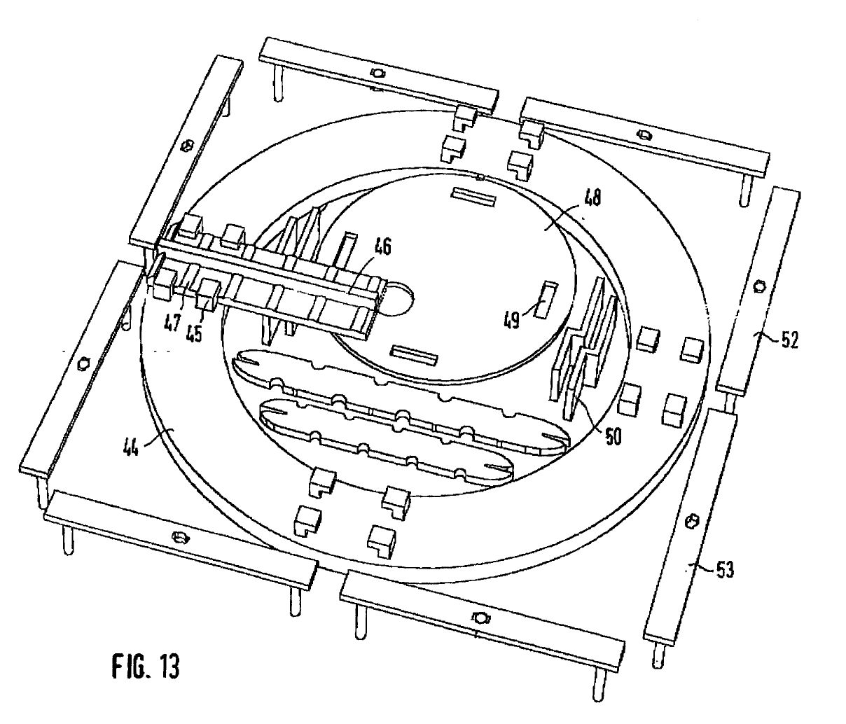

FIG. 13 shows a fifth example of the invention in the form an injection-molded part with individual parts, which can be severed,

FIG. 14 shows a setting-up device, assembled from individual parts of the injection molded part in FIG. 13, with Z-shaped extensions and

FIG. 15 shows the underside of a cross-shaped setting-up device.

FIG. 1 shows a perspective view of an injection-molded part 1, which shows all the individual parts of the device. Admittedly, the individual parts, injection molded in one mold, are joined together. However, they can be severed from one another easily and used separately. The injection-molded part 1 consists of a circular first setting-up device 2, which is disposed in the center of the injection molded part 1. The first setting-up device 2 can be placed in an outer pot, so that a flowerpot can be placed upon it in a somewhat elevated position. For this purpose, the first setting-up device 2 has a total of four circular openings 3, into each of which a foot 4 can be inserted. In the state as delivered, the feet 4 are disposed prone in appropriate recesses of the first setting-up device 2. The feet 4 are connected to the setting-up device 2 only by a few fastening points and can easily be severed. The feet 4 are inserted in the openings 3, so that the first setting-up device 2 permits a flowerpot to be set down in a somewhat elevated position in a first outer pot.

An annular surface adjoins the outside of the circular surface of the first setting-up device 2. This annular surface is a further first setting-up device 5, which similarly has openings 6 and feet 7. The feet 7 can be removed and inserted in the openings 6 so that a further first setting-up device with a larger diameter results. This is suitable for outer pots with a larger internal diameter.

An annular second setting-up device 8 adjoins the outside of this. Between the two rings 5, 8, there is a narrow ring-shaped space, which is interrupted by small fastening points, which are required for manufacturing reasons and ensure that the individual parts are held together. The second setting-up device can be placed on the upper edge of an outer pot, so that the flowerpot can be placed upon it. Alternatively, the second setting-up device 8 can also be inserted in a conical outer pot, so that it is held by friction at a certain height. Subsequently, the flowerpot, depending upon its size, is placed on the second setting-up device 8 or inserted in the latter, so that the flowerpot is held partly below and partly above the second setting-up device 8.

A further, second setting-up device 9, directly adjoins the outside of the second setting-up device 8. It is suitable for larger outer pots and can analogously be either set down on the outer pot or inserted in the opening. Moreover, the second setting-up device 9 has several removable wick holders 10, which are disposed in appropriate recesses of the setting-up device 9. The wick holder 10 is constructed flat and has an extended, essentially rectangular, outer contour. On the outside, it has a spiral on which a wick or the like is wound. The wick holder is inserted from the underside into a flowerpot, so that the plant can absorb moisture over the wick from the supply of water. The effective length of the moistened wick is increased appreciably in this way, as a result of which the watering is better and more uniform.

A total of four rod-shaped profiled sections 11, 12 is disposed at the outside of the ring-shaped setting-up device 9, so that, overall, a square outline results. The profiled sections 11, 12 can be placed on the second setting-up devices 8 and 9 and fastened so that the latter are reinforced cross-shaped. The injection molded part 1 comprises two lower profiled sections 11, on which an upper profiled section 12 is placed. For this purpose, the profiled sections 11, 12, in the region of their center, have appropriate recesses 13, which permit the cross-wise connection of two profiled sections 11, 12. Fastening to the setting-up devices 8, 9 is accomplished over locking elements 14, which are constructed as L-shaped angles. In the example shown, the free ends of the angle 14 point in each case from the center to the outside. In order to be able to utilize the device, the injection-molded part is split up by removing the individual part.

FIG. 2 shows a first setting-up device 2, which is placed in an outer pot 15. A setting-up device, the external diameter of which best fits the internal diameter of the outer pot 15, is selected from the setting-up devices 2, 5. The setting-up device 2 was provided on the underside with feet 4, so that it can be placed at a certain distance from the bottom of the outer pot 15.

As can be seen best in FIG. 6, the feet 4 are snapped into the openings 3 of the setting-up device 2 and held there. The circular setting-up device 2 has four rectangular recesses 16, which originally held the feet 4. A wick 19 can be passed through the recesses 16.

FIG. 4 shows a partially sectional view of the outer pot 15 of FIG. 2 with a flowerpot 17, placed in a lower position. Within the outer pot 15 there is a supply of water 18, which reaches approximately the lower edge of the setting-up device 2. The flowerpot 17 is connected over a wick 19 with the supply of water 18. One end of the wick 19 lies in the water. The other end of the wick 19 is wound on the wick holder 10, which is inserted from below into the flowerpot 17. For this purpose, the wick holder 10 is inserted through the recesses 16 of the setting-up device 2. The supply of water 18 is sufficient, for example, for three days without having to be replenished in this time. Only when the flowerpot is watered for the first time is it necessary to moisten the soil, contained in the flowerpot 17, from above. Subsequently, the amount of water required is absorbed by the plant itself from the water 18 supplied. Several wicks 19 or wick holders 10 can also be inserted in one flowerpot.

As shown in FIG. 3, the outside of the wick holder 10 has grooves, in which the wick 19 is wound, so that it cannot slip to one side. Likewise, the distribution of the moisture within the without pot is improved by these means.

The relatively small amount of water 18 lasts for five to seven days, depending on the size of the pot. A larger amount of water is required for supplying the plant during a longer absence, such as a vacation. As shown in FIG. 5, the flowerpot 17 can, in that case, be placed on the second setting-up device 8 in an elevated position. The first setting-up device 2 is not shown in FIG. 5, but can readily be left in the outer pot 15. Provisions can also be made so that it has a film hinge for folding up. As can be seen in FIG. 5, the second setting-up up device 8 rests on the upper edge of the outer pot 15. Moreover, profiled sections 11, 12 are disposed crosswise on the setting-up device 8, so that the flower pot 17 can be placed down on the profiled sections 11, 12. The length of the wick 19 is selected so that it reaches the bottom of the outer pot 15 even in the upper position, so that the plant is supplied with water even during an absence of several weeks. For setting down the outer pot 15 in the upper position, it is merely necessary to take the flowerpot 17 out of the outer pot 15, to fill the outer pot 15 with water, to place the setting-up device 8 on the outer pot and to place the flowerpot 17 thereon. During this procedure, the wick holder 10 can remain within the flowerpot so that the conversion can take place a very rapidly.

Some outer pots, such as pots produced from clay, are not watertight. Into these, a watertight vessel, such as a glass vessel filled with water, can be placed, on the upper side of which one of the setting-up devices is placed in order to form a support surface for a flowerpot. The plant is then supplied with moisture from the water in the glass vessel, into which the wick dips. Several glass containers can be placed in the outer pot in the case of larger, rectangular flower boxes or if the outer pot is shaped irregularly.

Figure is 7 shows the second setting-up device 8, to which the profiled sections 11, 12 are fastened, in plan view. The two profiled sections 11, 12 are disposed at right angles to one another, the respective center recesses 13 engaging one another. The upper sides of the profiled sections 11, 12 are in one plane, so that the flowerpot 17 can be placed stably on them.

The fastening of the profiled sections 11 is shown in FIG. 8. FIG. 8 is a partially sectional view along the line VIII-VIII of FIG. 7. The profiled section 11 has a locking section, which is constructed as angle 14. The free end of the angle 14 points radially to the outside from the center of the circle and is shaped so that it can embrace the inner edge of the setting-up device 8. The individual parts are produced from plastic, so that they are sufficiently flexible for holding the profiled section 11 at both sides at the setting-up device 8 by friction. The profiled sections 11, 12 are constructed as U-shaped profiles, the free legs pointing downward. Higher stability is achieved by these means.

FIG. 9 shows a further example with a larger number of individual parts. The injection-molded part 21 has a structure similar to that of the injection molded part 1. The first setting-up devices 2, 5 are identical. Adjoining these is a second setting-up device 22, which, in contrast to the first example, also has feet 23 and openings 24 for inserting the feet 23. By these means, the setting-up device 22 can be placed in an act of pot and a flowerpot held in the lower position. It can, however, be placed equally well on the upper edge of an outer pot and hold a flowerpot in the upper position. As a result, a larger range of flowerpots and outer pots of different sizes and shapes can be covered. A ring-shaped setting-up device 25 also adjoins the outside of the setting-up device 22. It has feet 26 and insertion openings 27, so that the setting-up device 25 is suitable for the lower as well as for the upper position. In addition, it contains a total of four wick holders 10, which are distributed to over the periphery and can be ripped out. The size of the wick holders 10 differs. Moreover, further wick holders are disposed in the corner regions, which are formed by the setting-up device 25 and adjacent profiled sections 11, 12. It is advisable to use several wick holders 10, 28 especially for larger plants, in order to water the whole of the flowerpot uniformly.

FIG. 10 shows a third example of the invention with a ring-shaped setting-up device 29. A total of four holding elements 30 is pushed radially unto the setting-up device 29. The structure and mode of functioning are evident from FIG. 11 which, in a sectional representation, shows the ring-shaped setting-up device 29 and the holding element 30, which is pushed onto the ring. The holding element 30 has a U-shaped cross section and is provided on the inside 31, 32 of the legs, which are disposed parallel to one another, with tooth-like projections. The upper side of the setting-of device 29 is constructed diametrically opposed and has a tooth structure on its upper side 33, so that the holding element can be interlocked with the setting-up device 29. As can be seen in FIG. 1, a total of four ring-shaped feet 34 are constructed around the setting-up device 29 on its underside. The end sections of the feet 34 are pointed, so that they can engage the opposite interstices of the holding element 30. A particularly secure hold is achieved by these means. Nevertheless, the holding elements 30 can be shifted inwards or outwards, radially to the setting-up device 29 by expending some force. After letting go, the tooth-like inner surfaces 31, 32 of the holding element 30 are held with the corresponding counter-surfaces of the setting-up device 29, so that all holding elements 30 are held securely at the setting-up device 29.

The thickness of the region connecting the upper and lower parts of the holding element 30 can be less, so that the holding element 30 functions like a film hinge. For this embodiment, the upper side and the underside of the holding element 30 need not terminate flush with one another in the region of the inner opening. Because of the flexible film hinge, the holding element 30 can also be connected with the setting-up device 29 with the upper side and the underside shifted relative to one another. For example, the underside of the holding element 30 can protrude further into the ring, so that a flowerpot can be placed on the lower leg of the holding element 30 and, at the same time, rest laterally against the upper leg of the holding element 30, which is shifted towards the outside.

It is a special advantage of the setting-up device 29 that the latter can be placed into a lower position in an outer pot without the holding elements, so that the flower pot, set down thereon, is held at a certain distance from the bottom of the outer pot. A certain amount of water can be filled into the outer pot and is then used for watering the flowerpot. Moreover, the same setting-up device can be placed in an upper position on the upper edge of the outer pot, the holding elements, fastened to the setting-up device, being shifted to adapt them to the respective size relationships.

FIG. 12 shows a fourth example of the invention with a setting-up device 36, which is constructed essentially circularly and on which a total of four pivotable holding elements 37 are fastened. The plate-shaped holding elements 37 are fastened to the setting-up device 36 in each case over a fastening point 38 in a corner by securing points 39, which are inserted through the holding elements 37 as well as through a corresponding borehole in the setting-up device 36. A securing point may also be integrally molded directly to the holding element or to the setting-up device and engage a borehole of the opposite part. At the same time, the fastening point 38 is a fulcrum for the holding elements 37. In this way, the size of the supporting surface for a flowerpot can be increased or decreased in the direction of the interior of the ring of the setting-up device 36 as well as to the outside. In order to prevent an unintentional shifting of the holding elements 37, various boreholes 40 are produced in the setting-up device 36, so that one of the boreholes 40 can be brought into alignment with a recess 41 of the holding element 37, in order to insert a securing pin through both components. The boreholes 41 or optionally several boreholes are produced at the end of the holding element 37, which is opposite the fastening point 38. Instead of the borehole, a securing pin may also be integrally molded to the holding element 37. As can be seen in FIG. 12, the inwardly pointing surface 42 of the holding element 37 is rounded. It is therefore also possible to insert a flowerpot in the setting-up device 38, so that the outer sides of the flowerpot are partially above and partially below the setting-up device 36 and the flowerpot is held by friction.

FIG. 13 shows a fifth example of the invention in the form of an injection-molded part with a plurality of individual parts. In order to improve clarity, the connecting pieces between the individual parts required for the injection molding, are not shown. The injection-molded part 43 is produced as a coherent component, from which the individual parts can be severed. At its underside, the setting-up device 44 in each case has two holding shoulders 45, which are disposed in pairs opposite one another and provided for fastening a holding element 46. For this purpose, several hump-like protrusions 47 are formed at the holding element 46, so that the holding element 46 can be pushed stepwise under the holding shoulders 45 of the setting-up device 44. Only a single holding element 46 is shown in FIG. 13. Preferably, however, four holding elements are mounted at the setting-up device 44.

Within the setting-up device 44, there is a setting-up device 48, which can be detached, is constructed circularly and has a total of four rectangular recesses 49. In addition, the injection-molded part includes further holding elements 50, which are doubly offset by 90°.

The construction and interaction of these individual parts is shown in FIG. 14. The holding elements 50 can be inserted in the recess 49 of the setting-up device 48. After the assembly, one surface of the holding elements 50 lies on the upper side of the setting-up device 49 while, at the same time, the opposite surface of the holding element 50 lies at the underside of the setting-up device 48. This contact, which is flat on both sides, results in a particularly stable surface for setting down a flowerpot. The injection-molded part 43 may also have holding elements 50 of different dimensions, with which the size can be varied correspondingly.

The injection-molded part 43 furthermore includes a series of spacers 52, 53, which are disposed on the outside around the setting-up device 44. In each case, two spacers 52, 53 can be assembled in cross-shaped fashion and form a further setting-up device, which can be placed in an outer pot and used to set down a flowerpot at a particular height. FIG. 15 shows the underside of a setting-up device, which is assembled from two spaces 52, 53. The upper spacer 53 has an essentially rectangular recess 54, so that it can be mounted in a certain relative position on a pin-like continuation 55 of the spacer 52. After the mounting, the spacer 53 is rotated until it is at right angles to the spacer 52. The spacers 52, 53 are secured in this position by the end section of the continuation 55 and the inverted cross-shaped setting-up device can be placed in an outer pot.

1. A device for watering a flowerpot, which can be placed in a lower position in an outer pot containing a supply of water at a distance from the bottom of the outer pot and set down in an upper position in the region of the upper edge of the outer pot, a wick being placed with one end in the flower pot for supplying it with water and, with the other end, into the supply of water, wherein the device has a first setting-up device (2, 5) for setting down the flowerpot (17) in a lower position and a second setting-up device (8, 9), which can be placed on the outer pot (15) or inserted in the outer pot (15) and held in the region of the upper edge of the outer pot (15) by friction, for placing the flowerpot (17) in the upper position.

2. The device of claim 1, wherein feet (4, 7, 23, 26) can be mounted detachably at the first and/or second setting-up device (2, 5, 8, 9, 22, 25).

3. The device of claims 1 or 2, wherein the setting-up devices (2, 5, 8, 9, 22, 25) are essentially ring-shaped or disk-shaped.

4. The device of one of the preceding claims, wherein profiled sections (11, 12) can be fastened detachably, preferably in the radial direction, at the second setting-up device (8, 9, 22, 25).

5. The device of claim 4, wherein mutually crossing profiled sections (11, 12), disposed preferably radially to the setting-up direction, can be fastened detachably to the second setting-up device (8, 9, 22, 25).

6. The device of claims 4 or 5, wherein the profiled sections (11, 12) protrude beyond the outside of the second setting-up device (8, 9, 22, 25).

7. The device of one of the claims 4 to 6, wherein the upper sides of the profiled sections (11, 12) lie in one plane.

8. The device of one of the preceding claims, wherein the flowerpot (15) can be inserted in the second setting-up device (8, 9, 22, 25) in such a way, that its outer surface essentially lies positively in contact with the inner ring surface.

9. The device of one of the preceding claims, wherein the end of the wick (19), which is connected with the flowerpot (15), can be wound around a rod-shaped wick holder (10, 28), which can be inserted into the flowerpot (15) through a hole at the underside of flowerpot (15).

10. The device of claim 9, wherein the wick holder (10, 28) has a groove, which extends at an angle along its longitudinal axis, for engaging the wick (19).

11. The device of one of the preceding claims, wherein the at least one foot (34) is integrally molded to the setting-up device (29) for setting it down in an outer pot.

12. The device of claim 11, wherein the foot (34) extends essentially around the setting-up device.

13. The device of claims 11, 12, wherein several feet (34), concentrically disposed, are integrally molded to the setting-up device (29).

14. The device of one of the proceeding claims, wherein holding elements (30, 37), which protrude over the setting-up device (29, 36) on the inside and/or the outside, can be fastened to the setting-up device (29, 36).

15. The device of claim 15, wherein the holding elements (30) are constructed U-shaped and, with their open side, can be pushed radially onto the setting-up device (29) and embrace the latter on the upper side and/or the underside.

16. The device of claims 14 or 15, wherein the setting-up device (29) has recesses and/or protrusions on its upper side (33) and/or in the region of the foot or feet (34) and/or the holding elements (30) have recesses and/or protrusions at their inner surfaces (31, 32).

17. The apparatus of claim 16, wherein the recesses and/or depressions of the setting-up device (29) and of the holding elements (30) are constructed diagrammatically opposed to one another and can be locked positively with one another.

18. The device of one of the claims 14 to 17, wherein the region connecting the upper and lower legs of the holding elements (30) is constructed as a film hinge.

19. The device of one of the preceding claims, wherein holding elements (37), which can be pivoted inward and/or outward, can be fastened detachably at the setting-up device (36).

20. The device of claim 19, wherein the setting-up device (36) has plug-in devices (40), into which securing pins (39) can be inserted for fastening the holding elements (37).

21. The device of claims 19 and 20, wherein securing pins (39) are integrally molded at the holding elements (37) or at the setting-up device (40).

22. The device of one of the preceding claims, wherein the setting-up device (44) has holding shoulders (45) can be pushed, under which the holding elements (46) for the purpose of locking.

23. The device of one of the preceding claims, wherein the setting-up device (48) has recesses (49), into which angular holding elements (50) can be inserted.

24. The device of claim 23, wherein a first surface of the holding element (50) lies in contact with the upper side and a second surface, which is essentially parallel to the first surface, lies in contact with the underside of the setting-up device (48).

25. The device of one of the preceding claims, wherein the device can be produced from plastic material.

26. The device of one of the preceding claims, wherein the device can be produced by injection molding.

27. The device of one of the preceding claims, wherein the coherent injection molded part (1, 21, 43) can be produced with individual parts, which can be severed and/or broken off.

28. The device of claim 27, wherein the injection-molded part (1, 21, 43) comprises individual parts for several, preferably two or three sets of devices.

29. The device of claim 28, wherein, in the case of an injection-molded part (1), comprising two sets of devices, the first setting-up devices (2) of the first set is circular and the first setting-up device (5) of the second set and the second setting-up devices (8, 9, 22, 26) of the first and second sets are constructed as concentric rings, the outer diameter of one part corresponding essentially to the inner diameter of the adjacent part.

30. The device of claims 28 or 29, wherein the injection molded part (1, 21) has at least four sections (11, 12), which are disposed preferably in rectangular fashion.

31. The device of one of the claims 4 to 30, wherein the or each profile section (11, 12) is constructed as a U-shaped profile.

32. The device of one of the claims 4 to 31, wherein each profile section (11, 12) has locking elements for locking to a setting-up surface (8, 9, 22, 25).

33. The device of one of the claims 4 to 32, wherein the locking elements of a profiled section (11, 12) are constructed as L-shaped angles (14), the free ends of which point from the center of a profiled section (11, 12) in the longitudinal direction to the outside.

34. The device of one of the claims 27 to 33, wherein the injection molded part (33) comprises removable space (52, 53), which can be assembled crosswise.
